(19) United States
(12) Patent Application Publication
(10) Pub. No.: US 2009/0282924 A1
(43) Pub. Date: Nov. 19, 2009

(54) Transducer Arrangement for a Nondestructive Material Testing System

(75) Inventors: Jürgen Götz, Hochstadt/Aisch (DE); Stefan Hain, Effeltrich (DE); Hubert Mooshofer, Munchen (DE); Jochen Ostermaier, Erlangen (DE); Fabricio De Carvalho Ferreira, Erlangen (DE)

Correspondence Address: King & Spalding LLP, 401 Congress Avenue, Suite 3200, Austin, TX, 78701, US

(73) Assignee: Siemens Aktiengesellschaft, Muenchen (DE)

(21) Appl. No.: 12/407,176

(22) Filed: Mar. 19, 2009

(30) Foreign Application Priority Data
Mar. 20, 2008 (DE) 102008015237.4

(51) Int. Cl. G01N 29/04

(52) U.S. Cl. 73/641

(57) ABSTRACT

A transducer arrangement for a nondestructive ultrasonic material testing system has a multiplicity of ultrasound transducers which can be moved linearly or swiveled along a trajectory curve. A multiplicity of ultrasound transducers can be aligned with a point of a specimen. If the size and the focal length of the transducers prohibit an annular or similar arrangement, the transducers are divided into smaller groups. They are then arranged so that every transducer passes over each desired focal point on the specimen during movement of the transducers along the trajectory curve.

### CROSS-REFERENCE TO RELATED APPLICATIONS

This application claims priority to German patent application No. 10 2008 015 237.4, filed Mar. 20, 2008. The complete disclosure of the above-identified priority application is hereby fully incorporated herein by reference.

### TECHNICAL FIELD

The invention relates to the field of nondestructive material testing. For this, there are a range of possibilities. For example radiation from a specimen to be tested, for example thermal radiation, may be received and evaluated using sensors. In this case, for example, the surface of the specimen is scanned. It is also possible to emit the radiation and then to receive and evaluate a reflected fraction of this radiation. The radiation may be electromagnetic radiation or sound waves, for example ultrasound. The invention deals in particular with an ultrasound transducer system, although it may also be used for other types of radiation. In the rest of the text, the term transducer will be used for a respective sensor or a combination of a sensor and an emitter for the radiation. For example, ultrasound transducer may refer to a pure ultrasound sensor or a component which operates both as an ultrasound transmitter and as an ultrasound receiver.

### BACKGROUND

Depending on the radiation being used, it may be necessary to maintain a particular distance of the transducer or transducers from the surface of the specimen. Furthermore, depending on the type of radiation being used, it may be necessary to maintain a particular angle with respect to the surface of the specimen. In the case of curved surfaces, for example hemispherical ends of a rod, to this end a swiveling system is usually required which can rotate the transducer or transducers about one or more swivel axes/rotation points. When testing the surface of a specimen, which is essentially rectilinear at least along one coordinate, a single- or multi-axis linear movement system is employed.

If for example particularly small defects in the material of the specimen are intended to be detected, i.e. when a high accuracy of the testing is required, it is expedient to carry out testing with a plurality of transducers, the transducers being aimed at the surface of the specimen from different directions. It is furthermore expedient to configure the transducers so that their beam strikes the surface of the specimen while being as focused as possible, i.e. it is focused onto as small as possible an area there, that is to say ideally onto a point. To this end, for example, an annular arrangement of the for example eight or 16 transducers is suitable, all of the transducers being aligned with one point. The distance of the transducers from the point, for example in the case of ultrasound transducers, is then only a few cm. Since the transducers themselves typically have a size in the range of at least a few mm, the described arrangement may be mechanically impossible.

Modifying the focal length, however, generally leads to a larger transducer diameter, or conversely reducing the transducer diameter leads to a decrease in the focal length. Modifying the distance degrades the focus of the beam of the transducers, and therefore the accuracy. A further possibility for resolving this problem would be sequential multiple scanning of the specimen, the position of the transducers being modified between the scans. This, however, leads to a greatly increased time expenditure for the complete test.

### SUMMARY

According to various embodiments, a nondestructive material testing device and a nondestructive material testing method can be provided with which the aforementioned problems are avoided, i.e. which allow testing with high speed and accuracy.

According to an embodiment, a device for nondestructive material testing may comprise at least two groups, respectively comprising at least one transducer, wherein the transducers of a first group are focused onto a first point; the respective transducers of further groups are focused onto a respective further point, which is different to the first point; the transducers are arranged so that they can be moved along a trajectory curve, and the transducers are arranged so that, for each of the further groups, a position in which the transducers of the group are focused onto the first point can be reached by movement along the trajectory curve.

According to a further embodiment, the trajectory curve may be a rectilinear trajectory or a circle. According to a further embodiment, the transducers can be displaced by a measurement distance along the trajectory curve between two measurements, and wherein the groups are arranged mutually displaced along the trajectory curve by a length which corresponds to a multiple of the measurement distance. According to a further embodiment, the transducers can be arranged so that the distance between the first and last transducers along the trajectory curve is minimal. According to a further embodiment, the transducers can be ultrasound transducers.

According to another embodiment, a method of nondestructive material testing in which a nondestructive material testing device having at least two groups, respectively comprising at least one transducer, is used, may comprise the step of: moving the transducers along a trajectory curve in order to scan a specimen, wherein—the transducers of a first group are focused at a first instant onto a first point, and—for each of the further groups, the transducers of the group are focused onto the first point at further instants.

According to a further embodiment, the extent of the specimen along the trajectory curve, plus a displacement length which corresponds to the distance between the first and last transducers along the trajectory curve, may be used as the length of the trajectory curve. According to a further embodiment, a rectilinear trajectory curve or a circular trajectory curve can be used. According to a further embodiment, the method may use a device as described above.

### BRIEF DESCRIPTION OF THE DRAWINGS

Other advantages and details of the invention will be explained with the aid of the exemplary embodiment represented in the drawing.

FIGS. 1 and 2 schematically show a transducer arrangement for scanning along a rectilinear trajectory, and

FIG. 3 schematically shows a transducer arrangement for scanning along a circle trajectory.

### DETAILED DESCRIPTION

The nondestructive material testing device according to various embodiments may have at least two groups respectively comprising at least one transducer, for example ultrasound transducers. The transducers of a first group are focused onto a first point, and the respective transducers of further groups are focused onto a respective further point, which is different to the first point. The transducers are furthermore arranged so that they can be moved along a trajectory curve, for example by means of a linear single- or multi-axis movement system and/or a swiveling system. Lastly, the transducers are arranged so that, for each of the further groups, a position in which the transducers of the group are focused onto the first point can be reached by movement along the trajectory curve. In particular, the transducers are arranged for common movement in a sensor holder.

In the nondestructive material testing method according to various embodiments, a nondestructive material testing device having at least two groups, respectively comprising at least one transducer, is used. The transducers are moved along a trajectory curve in order to scan a specimen. The transducers of a first group are focused at a first instant onto a first point, while for each of the further groups, the transducers of the group are focused onto the first point at further instants.

In other words the transducers of the nondestructive material testing device are divided into groups and are arranged so that by traveling along the trajectory curve, for example in order to scan the surface of a specimen, they sample a respective point of the surface successively instead of simultaneously. Testing of the surface with a desired high accuracy is therefore made possible, even though the transducers cannot be arranged so as to permit simultaneous testing of a respective point of the surface. This also allows the most suitable transducers to be used.

The trajectory curve may, for example, be a rectilinear trajectory or a circular trajectory. It is expedient for the trajectory curve to be configured in such a way that it essentially follows the surface of the specimen, so that the transducers maintain a particular distance from the surface. Preferably the extent of the specimen along the trajectory curve, plus a displacement length which corresponds to the distance between the first and last transducers along the trajectory curve, is used as the length of the trajectory curve. The trajectory curve is advantageously shortest when the transducers are arranged so that the distance between the first and last transducers along the trajectory curve is minimal.

Between two measurements, the transducers are expediently displaced by a particular measurement distance along the trajectory curve. It is advantageous for the groups, or the respective focal points of the groups, to be arranged mutually displaced along the trajectory curve by a length which corresponds to a multiple of the measurement distance. The effect achieved by this is that measurements by all the transducers are available for a particular set of points of the surface, and these measurements may advantageously be combined.

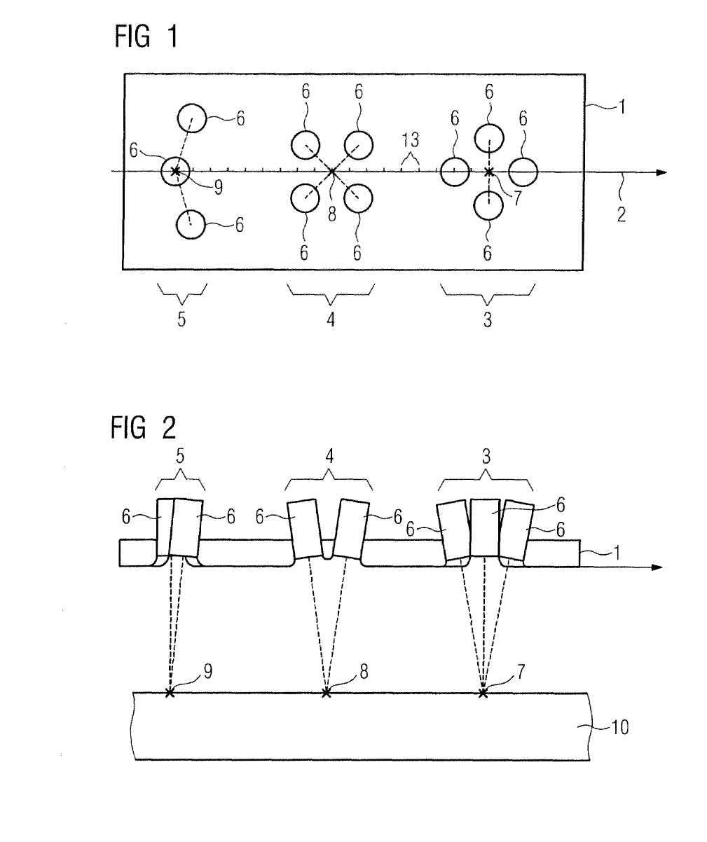

The first exemplary embodiment comprises a sensor holder 1. This is configured in order to scan an essentially rectilinear surface of a specimen 10. The specimen 10 may thus for example be a plate or a cylinder, for example a tube. The sensor holder 1 comprises eleven ultrasound transducers 6, which operate both as ultrasound emitters and as ultrasound sensors. FIG. 1 shows the sensor holder 1 in plan view, and FIG. 2 shows it in a side view. FIG. 2 also schematically indicates the specimen 10, in this example a tube, which is scanned lengthwise. An arrow in FIGS. 1 and 2 indicates the rectilinear trajectory 2 on which the sensor holder 1 is moved in order to scan the specimen 10. The ultrasound transducers 6 are approximately cylindrical, for which reason they are indicated as circles in the plan view.

The ultrasound transducers 6 are divided into three groups 3, 4, 5. The first and second groups 3, 4 respectively comprise four of the ultrasound transducers 6, and the third group 5 comprises three ultrasound transducers 6. The second group 4 is displaced along the rectilinear trajectory 2 relative to the first group 3 by a distance equal to about 450% of the diameter of the ultrasound transducers 6. The third group 5 is likewise displaced relative to the second group 4.

The ultrasound transducers 6 of the first group 3 are arranged at the corners of a square, the square being rotated by 45° with respect to the rectilinear trajectory 2. This means that two of the ultrasound transducers 6 of the first group are arranged centrally on the sensor holder 1 and follow one another on the rectilinear trajectory 2, while the other two ultrasound transducers 6 of the first group 3 are arranged perpendicularly next to the middle of the sensor holder 1 and at the same height with respect to the rectilinear trajectory 2. The mutual spacing of the ultrasound transducers 6 corresponds to about 120% of their diameter.

The ultrasound transducers 6 of the second group 4 are likewise arranged at the corners of a square, the square not being rotated with respect to the rectilinear trajectory 2. This means that all four ultrasound transducers 6 of the second group are arranged offset from the middle of the sensor holder 1 or the rectilinear trajectory 2 by the same distance, about 60% of the diameter of the ultrasound transducers 6, two on one side and two on the other side. Two of the ultrasound transducers 6 are in each case arranged at the same height with respect to the rectilinear trajectory 2. The mutual spacing of the ultrasound transducers 6 again corresponds to about 120% of their diameter.

One of the ultrasound transducers 6 of the third group 5 is arranged exactly centrally with respect the rectilinear trajectory 2. The other two ultrasound transducers of the third group 5 are arranged offset from the middle of the sensor holder 1 or the rectilinear trajectory 2 by the same distance, about 200% of the diameter of the ultrasound transducers 6, one on one side and one on the other side. The latter two ultrasound transducers 6 are arranged slightly offset along the rectilinear trajectory 2 relative to the first ultrasound transducer 6 of the first group 5.

The ultrasound transducers 6 of the first group 3 are arranged, i.e. installed tilted in the sensor holder 1, so that they are adjusted to a first focal point 7. Their ultrasound beam therefore arrives at the point 7 with a maximally optimal focus. The ultrasound transducers 6 of the second group 4 are arranged, i.e. installed tilted in the sensor holder 1, so that they are adjusted to a second focal point 8. The ultrasound transducers 6 of the third group 5 are arranged, i.e. some of them are installed tilted in the sensor holder 1, so that they are adjusted to a point 9. If the sensor holder is guided so that the surface of the specimen 10 passes through the focal points 7, 8, 9, then optimal accuracy of the testing is obtained. The sensor holder 1 is expediently guided over the length of the specimen 10 so that all the ultrasound transducers 6 of all the groups 3, 4, 5 scan the entire desired length of the specimen.

If the specimen 10 is now scanned, then the sensor holder 1 moves along the rectilinear trajectory 2 over the specimen 10. The ultrasound transducers 6 of the first group 3 pass over a particular point of the surface of the specimen 10 in the course of the movement. A short time later, the ultrasound transducers 6 of the second group 4 also pass over this point, as do the ultrasound transducers 6 of the third group 5 a further short time later. It is particularly advantageous for the mutual spacing of the groups 3, 4, 5, in particular the mutual spacing of the focal points 7, 8, 9, to be a multiple of the measurement distance 13. In the first exemplary embodiment presented, the groups 3, 4, 5 are mutually displaced by nine times the measurement distance 13. The effect achieved by this is that the further groups 4, 5 will also generate measurement values for a point of the surface of the specimen 10, for which the first group 3 has generated measurement values. For the points of the surface of the specimen 10 which are scanned, measurement values are therefore generated for which the ultrasound transducers 6 are arranged for example in a ring around the point and irradiate it at a desired angle, even though it is impossible to arrange the ultrasound transducers 6 on this ring with all the ultrasound transducers 6 being aligned with the same focal point 7, 8, 9, owing to their size. At the same time, this allows scanning of the surface in one run.

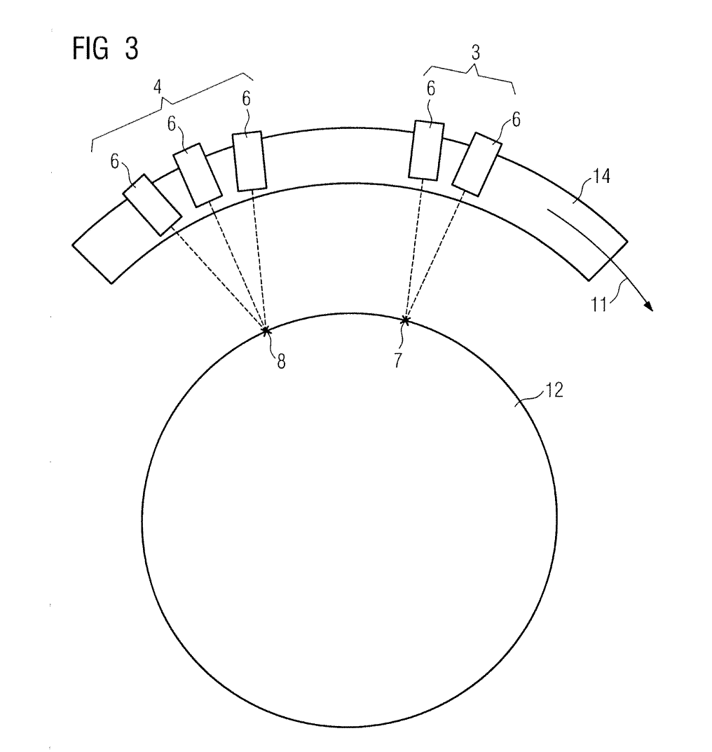

A second exemplary embodiment is outlined in FIG. 3. The sensor holder 14 in this example is configured as a circle arc and is used to scan a round, for example cylindrical or spherical specimen 12. To this end, the sensor holder 14 is moved on a circular trajectory 11 around the specimen 12. The sensor holder 14 has two groups 3, 4 of in total five ultrasound transducers 6. The two ultrasound transducers 6 of the first group 3 are aligned with a first focal point 7, and the three ultrasound transducers 6 of the second group 4 are aligned with a second focal point 8. The arrangement of the ultrasound transducers 6 and the alignment with the focal points 7, 8 are configured so that the ultrasound transducers 6 again pass over the same points when the sensor holder 14 moves on the circular trajectory 11, so that the same advantages are achieved as for the rectilinear trajectory 2.

For complete scanning of a hemispherical specimen 12, there are several possibilities: for instance, the sensor holder 14 may be moved so that a quadrant of the surface of the specimen 12 is scanned in each case, and the specimen is rotated in total through 360° in order to scan the entire hemisphere. It is likewise possible to cover a semicircle and rotate the specimen in total through 180°. A third variant is obtained by some of the ultrasound transducers 6 scanning a region of more than a quadrant of the surface while swiveling the sensor holder 14 through 900°. These additional data may be used to increase the accuracy of the measurement, since extra data are therefore available at least for a part of the surface of the specimen.

What is claimed is:

1. A device for nondestructive material testing comprising at least two groups, respectively comprising at least one transducer, wherein:
the transducers of a first group are focused onto a first point;
the respective transducers of further groups are focused onto a respective further point, which is different to the first point;
the transducers are arranged so that they can be moved along a trajectory curve,
the transducers are arranged so that, for each of the further groups, a position in which the transducers of the group are focused onto the first point can be reached by movement along the trajectory curve.

2. The device according to claim 1, wherein the trajectory curve is a rectilinear trajectory or a circle.

3. The device according to claim 1, wherein the transducers are displaced by a measurement distance along the trajectory curve between two measurements, and wherein the groups are arranged mutually displaced along the trajectory curve by a length which corresponds to a multiple of the measurement distance.

4. The device according to claim 1, wherein the transducers are arranged so that the distance between the first and last transducers along the trajectory curve is minimal.

5. The device according to claim 1, wherein the transducers are ultrasound transducers.

6. A method of nondestructive material testing in which a nondestructive material testing device having at least two groups, respectively comprising at least one transducer, is used, the method comprising the step of:
moving the transducers along a trajectory curve in order to scan a specimen, wherein
the transducers of a first group are focused at a first instant onto a first point, and
for each of the further groups, the transducers of the group are focused onto the first point at further instants.

7. The method according to claim 6, wherein the extent of the specimen along the trajectory curve, plus a displacement length which corresponds to the distance between the first and last transducers along the trajectory curve, is used as the length of the trajectory curve.

8. The method according to claim 6, wherein a rectilinear trajectory curve or a circular trajectory curve is used.

9. The method as claimed according to claim 6, comprising the step of using a device for nondestructive material testing comprising at least two groups, respectively comprising at least one transducer, wherein the transducers of a first group are focused onto a first point; the respective transducers of further groups are focused onto a respective further point, which is different to the first point; the transducers are arranged so that they can be moved along a trajectory curve, and the transducers are arranged so that, for each of the further groups, a position in which the transducers of the group are focused onto the first point can be reached by movement along the trajectory curve.

10. The method according to claim 9, wherein the trajectory curve is a rectilinear trajectory or a circle.

11. The method according to claim 9, wherein the transducers are displaced by a measurement distance along the trajectory curve between two measurements, and wherein the groups are arranged mutually displaced along the trajectory curve by a length which corresponds to a multiple of the measurement distance.

12. The method according to claim 9, wherein the transducers are arranged so that the distance between the first and last transducers along the trajectory curve is minimal.

13. The method according to claim 9, wherein the transducers are ultrasound transducers.

14. A method for nondestructive material testing with a device having at least two groups, respectively comprising at least one transducer, the method comprising the steps of:
focusing the transducers of a first group onto a first point;
focusing the respective transducers of further groups onto a respective further point, which is different to the first point;
arranging the transducers so that they can be moved along a trajectory curve,
arranging the transducers so that, for each of the further groups, a position in which the transducers of the group are focused onto the first point can be reached by movement along the trajectory curve.

15. The method according to claim 14, wherein the trajectory curve is a rectilinear trajectory or a circle.

16. The method according to claim 14, wherein the transducers are displaced by a measurement distance along the trajectory curve between two measurements, and wherein the groups are arranged mutually displaced along the trajectory curve by a length which corresponds to a multiple of the measurement distance.

17. The method according to claim 14, wherein the transducers are arranged so that the distance between the first and last transducers along the trajectory curve is minimal.

18. The method according to claim 14, wherein the transducers are ultrasound transducers.
